(19) United States
(12) Patent Application Publication
(10) Pub. No.: US 2026/0299556 A1
(43) Pub. Date: Oct. 1, 2026

(54) PROCESSING CONTROL DEVICE AND NON-TRANSITORY COMPUTER-READABLE STORAGE MEDIUM

(71) Applicant: FANUC CORPORATION, Minamitsuru-gun, Yamanashi (JP)

(72) Inventors: Masanobu HATADA, Yamanashi (JP); Takahiro TANAKA, Yamanashi (JP)

(73) Assignee: FANUC CORPORATION, Minamitsuru-gun, Yamanashi (JP)

(21) Appl. No.: 18/992,832

(22) PCT Filed: Aug. 26, 2022
(86) PCT No.: PCT/JP2022/032294

§ 371 Date: Jan. 9, 2025

(51) Int. Cl. G05B 19/4155

(52) U.S. Cl. CPC G05B 19/4155; G05B 2219/45165

(57) ABSTRACT

The purpose of the present disclosure is to mitigate the burden on a user who, whenever a processing machine is used, selectively executes a switching program corresponding to the type of the processing machine. A laser processing control device according to the present disclosure controls a processing system for using a processing machine to process a workpiece, the laser processing control device having a registration unit, a storage unit, and a switching unit. The registration unit is configured to be able to register, by means of a manipulation by a user, a switching program for switching the state of the processing machine between an initial state in which a prescribed operation for processing the workpiece cannot be executed and a preparation completed state in which the prescribed operation can be executed. The storage unit stores the registered switching program. The switching unit reads out and executes the switching program from the storage unit in accordance with the usage of the processing machine.

### TECHNICAL FIELD

The present disclosure relates to a processing control device that controls a processing system that performs processing.

### BACKGROUND ART

In processing systems, for example, there has been one that performs laser processing on a workpiece such as a steel plate by emitting a laser outputted from a laser oscillator toward the workpiece via a processing nozzle.

### CITATION LIST

### Patent Document

Patent Document 1: Japanese Unexamined Patent Application, Publication No. 2007-30031

### DISCLOSURE OF THE INVENTION

### Problems to be Solved by the Invention

The laser oscillator is not able to output a laser in an initial state in which only a power source is turned on. Therefore, it has been necessary to execute predetermined starting processing to switch the laser oscillator from the initial state to a preparation completion state in which the laser is outputtable. However, the starting processing may vary depending on a type of the laser oscillator. Furthermore, ending processing for returning the laser oscillator from the preparation completion state to the initial state may also vary depending on the type of the laser oscillator.

Therefore, it has been necessary to introduce a programmable logic controller (PLC), for example, in a laser processing control device and for a user, by using the PLC, by a ladder, for example, to selectively execute switching programs including a starting program and an ending program, for example, corresponding to a type of a laser oscillator each time start or end of using the laser oscillator. Furthermore, similar issues may arise in various types of processing machines other than the laser oscillator.

In view of the situations described above, an object of the present disclosure is to mitigate a burden on a user of selectively executing a switching program corresponding to a type of processing machine each time the processing machine is used.

### Means for Solving the Problems

A processing control device according to the present disclosure is
a processing control device that controls a processing system that uses a processing machine to process a workpiece,
including;
a registration unit configured to allow registration, through a manipulation by a user, of a switching program for switching a state of the processing machine between an initial state in which a predetermined operation for processing the workpiece is not executable and a preparation completion state in which the predetermined operation is executable;
a storage unit that stores the switching program that has been registered; and
a switching unit that reads, from the storage unit, and
executes the switching program in accordance with using of the processing machine.

A processing control program according to the present disclosure is
a processing control program for causing a computer to function as a processing control device that controls a processing system that uses a processing machine to process a workpiece, and
for causing the computer to further function as:
a registration unit configured to allow registration, by a user, of a switching program for switching a state of the processing machine between an initial state in which a predetermined operation for processing the workpiece is not executable and a preparation completion state in which the predetermined operation is executable;
a storage unit that stores the switching program that has been registered; and
a switching unit that reads, from the storage unit, and
executes the switching program in accordance with using of the processing machine.

### Effects of the Invention

According to the present disclosure, it is possible to mitigate a burden on a user of selectively executing a switching program corresponding to a type of processing machine each time the processing machine is used.

### BRIEF DESCRIPTION OF THE DRAWINGS

FIG. 1 is a configuration diagram illustrating a laser processing control device according to a first embodiment;

FIG. 2 is a diagram illustrating starting processing according to a comparative example;

FIG. 3 is a diagram illustrating starting processing according to the present embodiment;

FIG. 4 is a diagram illustrating ending processing according to a comparative example;

FIG. 5 is a diagram illustrating ending processing according to the present embodiment;

FIG. 6 is a configuration diagram illustrating a laser processing control device according to a second embodiment;

FIG. 7 is a diagram illustrating starting processing according to a comparative example;

FIG. 8 is a diagram illustrating starting processing according to the present embodiment;

FIG. 9 is a diagram illustrating ending processing according to a comparative example;

FIG. 10 is a diagram illustrating ending processing according to the present embodiment;

FIG. 11 is a configuration diagram illustrating a laser processing control device according to a third embodiment;

FIG. 12 is a diagram illustrating starting processing according to a fourth embodiment; and

FIG. 13 is a diagram illustrating ending processing.

### PREFERRED MODE FOR CARRYING OUT THE INVENTION

Embodiments of the present disclosure will now be described herein with reference to the accompanying drawings. However, the present disclosure is not limited to the embodiments described below. It is possible to appropriately make modifications and implementations without departing from the scope of the present disclosure.

### First Embodiment

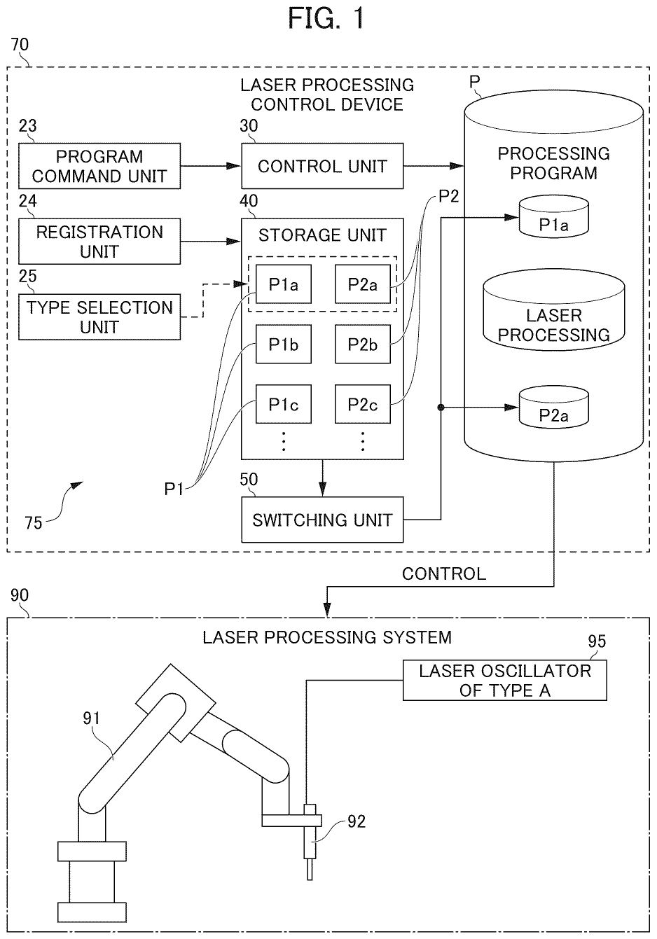

A first embodiment will now first be described herein with reference to FIGS. 1 to 5. As illustrated in FIG. 1, a laser processing control device 70 controls a laser processing system 90. The laser processing system 90 includes an arm 91 of a robot, a processing nozzle 92, and a laser oscillator 95. The arm 91 movably holds the processing nozzle 92. The laser oscillator 95 is coupled to the processing nozzle 92 to input a laser to the processing nozzle 92. The laser inputted from the laser oscillator 95 is emitted from the processing nozzle 92 toward a workpiece (not shown) for performing laser processing. Specifically, the laser oscillator 95 according to the present embodiment is the laser oscillator 95 of Type A. Note that Type A may be read as a “first type”.

The laser oscillator 95 is not able to output the laser in an initial state in which only a power source is turned on. A state of the laser oscillator 95, in which the laser is not outputtable, will be hereinafter referred to as the “initial state”, and a state of the laser oscillator 95, in which the laser is outputtable, will be hereinafter referred to as a “preparation completion state”. Specifically, for example, the initial state is a state in which the laser oscillator 95 is not able to output the laser since a state in which no coolant flows (a state in which no chiller is started) or a power saving state (a state in which no LD power source is powered). The preparation completion state is a state in which the laser oscillator 95 is able to output the laser since a coolant flows, an inside temperature stabilizes, the power saving state is released, and laser oscillation occurs.

A state before start of laser output from the laser oscillator 95 to the processing nozzle 92 will be hereinafter referred to as “before using the laser oscillator 95”, and a state after completion of the laser output from the laser oscillator 95 to the processing nozzle 92 will be hereinafter referred to as “after using the laser oscillator 95”. Before using the laser oscillator 95, it is necessary to execute predetermined “starting processing” to switch the laser oscillator from the initial state to the preparation completion state. Then, after using the laser oscillator 95, it is necessary to execute predetermined “ending processing” to return the laser oscillator 95 from the preparation completion state to the initial state.

The laser processing control device 70 is a robot control device in the present embodiment, and is configured to mainly include one computer and a laser processing control program that has been read in the computer. However, instead of this configuration, it may be configured to mainly include a plurality of computers and a laser processing control program including programs that have been respectively read in the plurality of computers. The computer includes, for example, a CPU, ROM, RAM, and a non-volatile memory. The laser processing control program cooperates with the computer to cause the computer to function as the laser processing control device 70.

The laser processing control device 70 includes a program command unit 23 and a control unit 30. The program command unit 23 is configured to mainly include the computer, its display, a keyboard, and a mouse, for example. The program command unit 23 is configured to allow input of a processing program P through a manipulation by a user, for example. Specifically, for example, the program command unit 23 is configured to allow input of the processing program P by using a predetermined program language such as an NC language, a C language, C++, or Python.

The control unit 30 is configured to mainly include the CPU and the RAM, for example, in the computer. The control unit 30 executes the processing program P inputted in the program command unit 23 to control the laser processing system 90. Thereby, the control unit 30 causes the laser processing system 90 to implement laser processing.

As described above, the laser oscillator 95 is not able to output the laser in the initial state in which only the power source is turned on. Therefore, the laser processing control device 70 further includes an automatic switching unit 75 for switching the state of the laser oscillator 95 between the initial state and the preparation completion state. The automatic switching unit 75 includes a registration unit 24, a type selection unit 25, a storage unit 40, and a switching unit 50.

The registration unit 24 is configured to mainly include the computer, its display, the keyboard, and the mouse, for example. The registration unit 24 is configured to allow registration of switching programs P1 and P2 for switching the state of the laser oscillator 95 through a manipulation by the user for each of Types A, B, and C . . . of the laser oscillators 95. The switching programs P1 and P2 include the “starting program P1” for switching the state of the laser oscillator 95 from the initial state to the preparation completion state and the “ending program P2” for returning the state of the laser oscillator 95 from the preparation state to the initial state. The user is able to input, through a manipulation on the registration unit 24, the type of the laser oscillator 95 and the switching programs P1 and P2 corresponding to the type, and, thereby, is able to register the switching programs P1 and P2 corresponding to the type of the laser oscillator 95.

Specifically, in the present embodiment, as described above, the laser processing system 90 includes the laser oscillator 95 of Type A. Therefore, in the present embodiment, the user inputs, through a manipulation on the registration unit 24, at least Type A and a starting program P1a and an ending program P2a corresponding to the type. The registration unit 24 is configured to allow input of the switching programs P1 and P2 by way of the predetermined program language described above, that is, by using a program language that is usable when inputting the processing program P into the program command unit 23.

The storage unit 40 is configured to mainly include parts including the non-volatile memory, for example, in the computer. The storage unit 40 stores the type of the laser oscillator 95, which has been inputted through the manipulation on the registration unit 24 by the user, and the switching programs P1 and P2 corresponding to the type. Furthermore, the storage unit 40 may store, in advance, in a state in which the laser processing control device 70 is a new one, that is, in a state of shipping from a factory, for example, a predetermined type and a whole or a part of the switching programs P1 and P2 corresponding to the type. That is, the storage unit 40 may not only store, in advance, through a manipulation on the registration unit 24 by the user, a desired type and the switching programs P1 and P2 corresponding to the type, but also further store, through a manipulation by a worker in a factory, for example, a predetermined type and at least a part of the switching programs P1 and P2 corresponding to the type. In this case, in a state before registration of the switching programs P1 and P2 through a manipulation on the registration unit 24 by the user, the storage unit 40 has already stored at least a part of the switching programs P1 and P2 corresponding to the predetermined type of the laser oscillator 95. Therefore, it is possible to mitigate a burden on the user to register at least a part of the switching programs P1 and P2 corresponding to the predetermined type.

The type selection unit 25 is configured to mainly include the computer, its display, the keyboard, and the mouse, for example. The type selection unit 25 is configured to allow selection of a type of the laser oscillator 95 through a manipulation by the user. Specifically, in the present embodiment, the user selects Type A through a manipulation on the type selection unit 25.

The switching unit 50 is configured to mainly include parts including the CPU and the RAM, for example, in the computer. The switching unit 50 reads, from the storage unit 40, and executes the switching programs P1 and P2 for the selected type in accordance with using of the laser oscillator 95 based on execution of the processing program P. That is, in the present embodiment, the switching programs P1 and P2 for Type A are read and executed. Specifically, the switching unit 50 executes the starting program P1a for Type A before start of laser processing, that is, before using the laser oscillator 95 of Type A. Then, the switching unit 50 executes the ending program P2a for Type A after end of the laser processing, that is, after using the laser oscillator 95 of Type A.

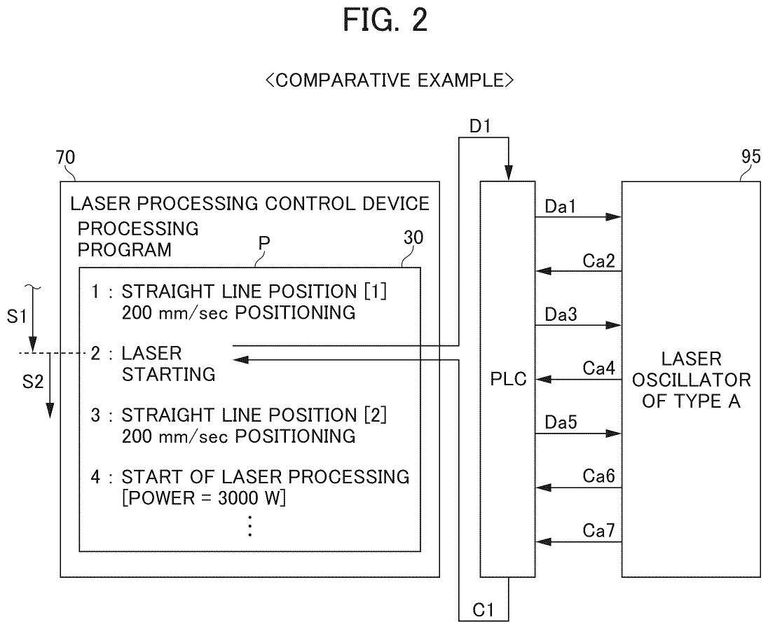

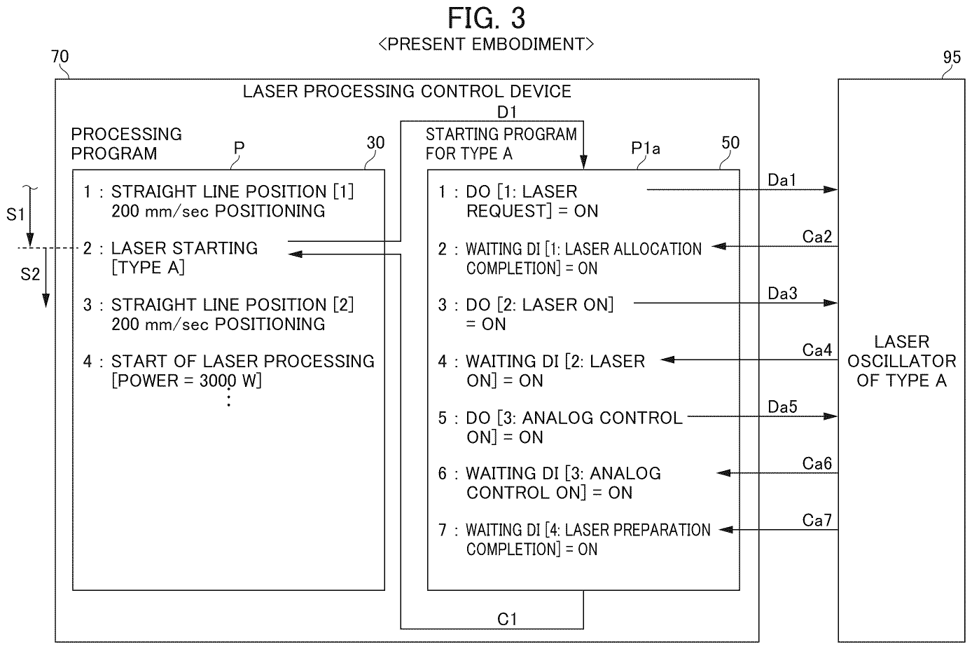

Next, starting processing performed in the present embodiment will now be described herein with reference to FIGS. 2 and 3. If the laser processing control device 70 does not include the automatic switching unit 75, as in a comparative example illustrated in FIG. 2, it is necessary to introduce a programmable logic controller (PLC) in the laser processing control device 70 in advance. Then, the user needs, by using the PLC, by a program language such as a ladder, to selectively execute a starting program corresponding to Type A each time before start of laser processing.

On the other hand, in the present embodiment, as described above, the automatic switching unit 75 has been included, and, through a manipulation on the registration unit 24 by the user, the starting program P1a for Type A has been registered and stored in the storage unit 40. Then, through a manipulation on the type selection unit 25 by the user, Type A has been selected. Therefore, as illustrated in FIG. 3, before start of laser processing based on the processing program P, the switching unit 50 automatically reads, from storage unit 40, and executes the starting program P1a for Type A in accordance with a starting request D1 provided from the control unit 30. Thereby, the starting processing for Type A is automatically executed.

Specifically, in the starting processing for Type A, the laser processing control device 70 first transmits, to the laser oscillator 95, a laser request Da1 for requesting permission for performing control by the laser processing control device 70. As the laser request Da1 is received, the laser oscillator 95 grants permission for performing control under a condition that a predetermined requirement is satisfied, and transmits a laser allocation completion signal Ca2 to the laser processing control device 70. As the laser allocation completion signal Ca2 is received, the laser processing control device 70 transmits a laser ON request Da3 to the laser oscillator 95. As the laser ON request Da3 is received, the laser oscillator 95 switches itself from the initial state to the preparation completion state, and transmits a laser ON signal Ca4 to the laser oscillator 95. As the a laser ON signal Ca4 is received, the laser processing control device 70 transmits an analog control ON request Da5 for requesting permission for performing analog control by the laser processing control device 70 to the laser oscillator 95. As the analog control ON request Da5 is received, the laser oscillator 95 grants permission for performing analog control under a condition that a predetermined requirement is satisfied, transmits an analog control ON signal Ca6 to the laser processing control device 70, and transmits a laser preparation completion signal Ca7 to the laser processing control device 70.

As described above, the starting processing for the laser oscillator 95 of Type A is completed. Therefore, the user does not need, by using a PLC, by a program language such as a ladder, to selectively execute a starting program corresponding to Type A each time before start of laser processing.

After completion of the starting processing, the switching unit 50 transmits a starting completion notification C1 to the control unit 30. Thereby, the control unit 30 starts to use the laser oscillator 95 of Type A to start laser processing.

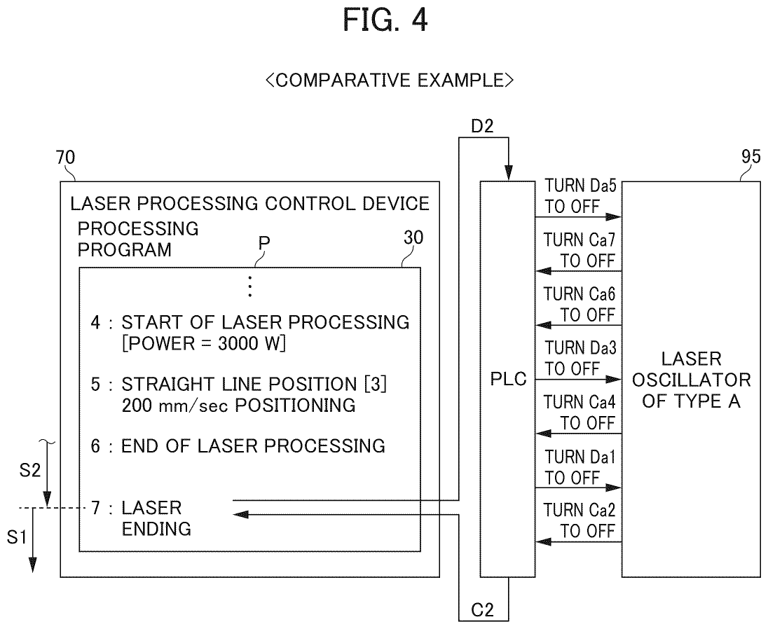

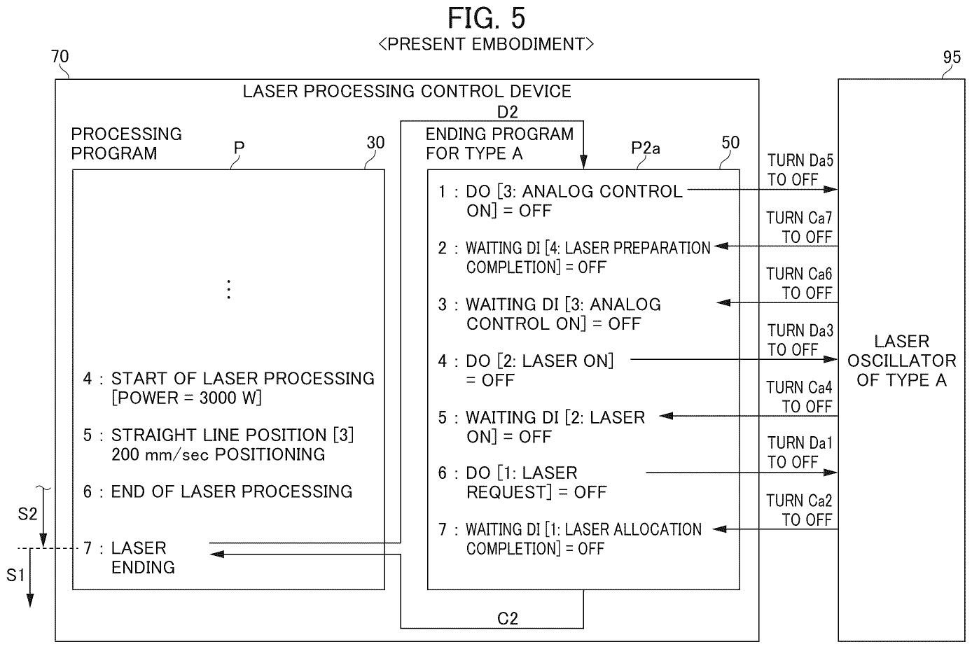

Next, ending processing performed in the present embodiment will now be described herein with reference to FIGS. 4 and 5. If the laser processing control device 70 does not include the automatic switching unit 75, as in a comparative example illustrated in FIG. 4, it is necessary to introduce a PLC in the laser processing control device 70 in advance. Then, the user needs, by using the PLC, by a program language such as a ladder, to selectively execute an ending program corresponding to Type A each time after end of the laser processing.

On the other hand, in the present embodiment, as illustrated in FIG. 5, after end of the laser processing based on the processing program P, the switching unit 50 automatically reads, from the storage unit 40, and executes the ending program P2a for Type A in accordance with an ending request D2 provided from the control unit 30. Thereby, the ending processing for Type A is automatically executed.

Specifically, in the ending processing for Type A, the laser processing control device 70 first turns the analog control ON request Da5 to OFF. Based on this setting, the laser oscillator 95 turns the laser preparation completion signal Ca7 to OFF, cancels the granted permission for performing the analog control, and turns the analog control ON signal Ca6 to OFF. After that, the laser processing control device 70 turns the laser ON request Da3 to OFF. Based on this setting, the laser processing control device 70 turns the laser ON signal Ca4 to OFF. After that, the laser processing control device 70 turns the laser request Da1 to OFF. Based on this setting, the laser processing control device 70 turns the laser allocation completion signal Ca2 to OFF.

As described above, the ending processing for the laser oscillator 95 of Type A is completed. Therefore, the user does not need, by using a PLC, by a program language such as a ladder, to selectively execute an ending program corresponding to Type A each time after end of the laser processing.

After completion of the ending processing, the switching unit 50 transmits an ending completion notification C2 to the control unit 30. Thereby, the control unit 30 starts next processing based on the processing program P.

As described above, in the present embodiment, the starting program P1a for Type A is automatically implemented before implementation of laser processing based on the processing program P, and the ending program P2a for Type A is automatically implemented after implementation of the laser processing based on the processing program P.

Furthermore, in addition to before and after implementation of laser processing based on the processing program P, the switching unit 50 reads, from the storage unit 40, and executes the switching programs P1 and P2 in those cases described below, for example. That is, when laser processing is interrupted due to emergency stop or when laser processing is interrupted due to a command other than a command based on a processing program, the switching unit 50 reads, from the storage unit 40, and executes the ending program P2a corresponding to Type A that has been selected. Then, when the laser processing is to be restarted after the laser processing has been interrupted, the switching unit 50 reads, from the storage unit 40, and executes the starting program P1a correspond to Type A that has been selected.

On the other hand, even in one of the situations in which the starting program P1a should be implemented, as described above, the switching unit 50 skips execution of the starting program P1 during a laser processing disabled period in which a manipulation based on which laser processing should be disabled has been performed. The laser processing disabled period includes, for example, a period of a teaching mode under which the user teaches the laser processing system 90 an operation.

The configuration and effects of the present embodiment will now be summarized below.

The registration unit 24 is configured to allow registration of the switching programs P1 and P2 for switching the state of the laser oscillator 95 through a manipulation by the user, and the switching unit 50 reads, from the storage unit 40, and executes the switching programs P1 and P2 that have been registered, in accordance with using of the laser oscillator 95. Therefore, it is not necessary to prepare a PLC for switching the state of the laser oscillator 95.

Specifically, before using the laser oscillator 95 of Type A, the switching unit 50 reads, from the storage unit 40, and executes the starting program P1a corresponding to Type A. Therefore, the user does not need, by using a PLC, by a program language such as a ladder, to selectively execute a starting program corresponding to Type A each time before using the laser oscillator 95.

Furthermore, after using the laser oscillator 95, the switching unit 50 reads, from the storage unit 40, and executes the ending program P2a corresponding to Type A. Therefore, the user does not need, by using a PLC and a program language such as a ladder to selectively execute an ending program corresponding to Type A after using the laser oscillator 95.

The registration unit 24 is configured to allow registration of the switching programs P1 and P2 for each of Types A, B, and C . . . of the laser oscillators 95. The switching unit 50 reads, from the storage unit 40, and executes the switching programs P1 and P2 corresponding to a type selected by the user through a manipulation on the type selection unit 25. Therefore, even when a plural types (A, B, and C . . . ) of the laser oscillators 95 are assumed to be used, it can be handled

[symbol]

The switching unit 50 reads, from the storage unit 40, and executes the switching programs P1 and P2 in accordance with using of the laser oscillator 95 based on execution of the processing program P. Therefore, in synchronization with the processing program P and at efficient and appropriate timings, it is possible to execute the starting program P1 and the ending program P2.

The registration unit 24 is configured to allow input of the switching programs P1 and P2 by way of a program language that allows the processing program P to be input into the program command unit 23. Therefore, even when it is impossible for the user to use a program language for a PLC, such as a ladder, the user is able to respond to such a case.

When laser processing has been interrupted, the switching unit 50 reads, from the storage unit 40, and executes the ending program P2. Therefore, when laser processing has been interrupted, it is possible to promptly end the laser oscillator 95.

When the laser processing is to be restarted after the laser processing has been interrupted, the switching unit 50 reads, from the storage unit 40, and executes the starting program P1. Therefore, when laser processing is to be restarted, it is possible to promptly start the laser oscillator 95.

During a laser processing disabled period in which a manipulation based on which laser processing should be disabled is performed, the switching unit 50 skips execution of the starting program P1. Therefore, the laser processing system 90 is not able to emit laser even by mistake, making it thereby possible to further secure safety.

Specifically, the laser processing disabled period includes a period in which a teaching mode under which the user teaches the laser processing system 90 an operation is selected. Therefore, it is possible to further secure safety under the teaching mode.

Through cooperation between the computer and the laser processing control program in the present embodiment, the computer is allowed to function as the program command unit 23 and the control unit 30, and to further function as the automatic switching unit 75. That is, the computer is allowed to function as the laser processing control device 70 according to the present embodiment. Therefore, it is possible to utilize the computer to achieve the present embodiment.

### Second Embodiment

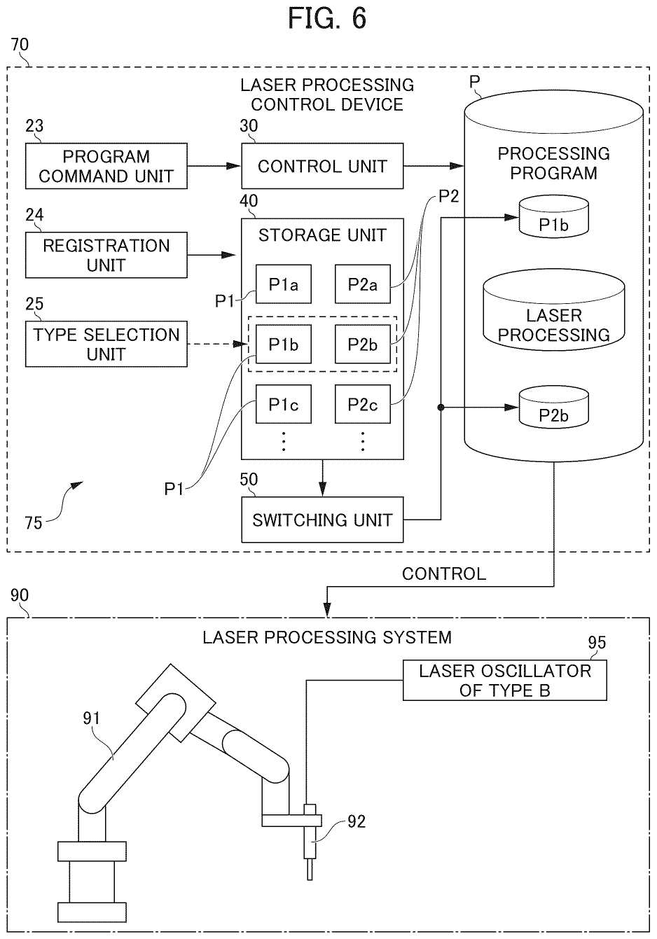

Next, a second embodiment will now be described herein with reference to FIGS. 6 to 10. For the embodiment described below, its description will be given based on the first embodiment, but by focusing on those points different from the first embodiment. Descriptions of those that are identical or similar to the first embodiment will thus be appropriately omitted.

In the present embodiment, as illustrated in FIG. 6, the laser processing system 90 includes the laser oscillator 95 of Type B, instead of the laser oscillator 95 of Type A illustrated in the first embodiment. Therefore, in the present embodiment, the user selects Type B through a manipulation on the type selection unit 25. Note that Type B may be read as a “second type”.

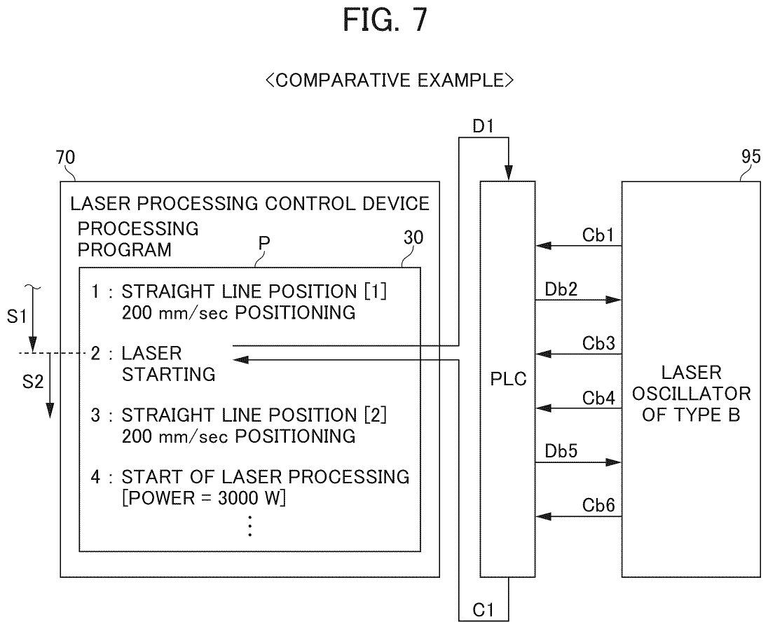

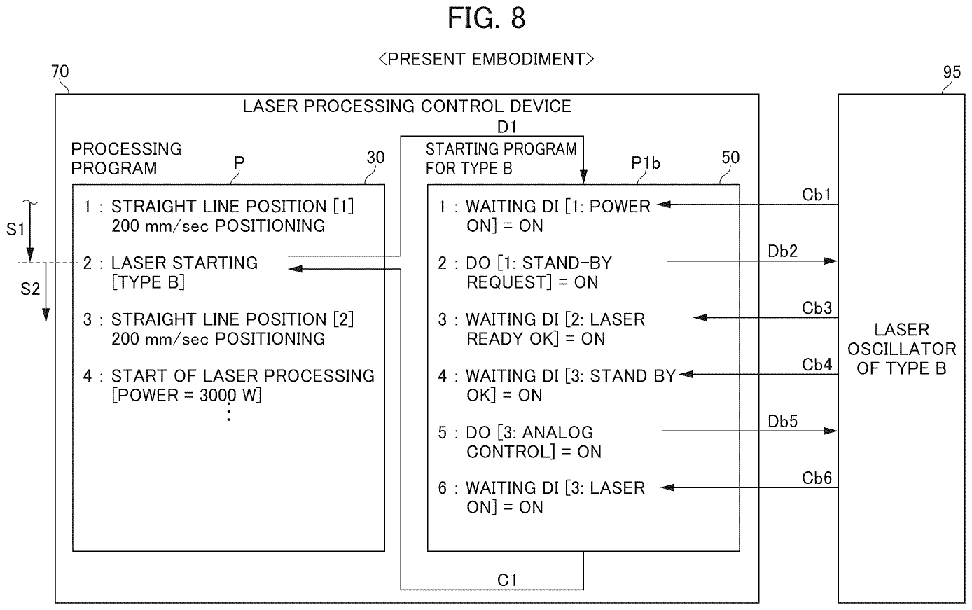

Next, starting processing performed in the present embodiment will now be described herein with reference to FIGS. 7 and 8. If the laser processing control device 70 does not include the automatic switching unit 75, as in a comparative example illustrated in FIG. 7, it is necessary to introduce a PLC in advance. Then, the user needs, by using the PLC, by a program language such as a ladder, to selectively execute a starting program corresponding to Type B each time before start of laser processing.

On the other hand, in the present embodiment, as illustrated in FIG. 8, before start of laser processing based on the processing program P, the switching unit 50 automatically reads, from the storage unit 40, and executes a starting program P1b for Type B in accordance with a starting request D1 provided from the control unit 30. Thereby, the starting processing for Type B is automatically executed.

Specifically, in the starting processing for Type B, the laser oscillator 95 first transmits a power on signal Cb1 indicating that power is on to the laser processing control device 70. As the power on signal Cb1 is received, the laser processing control device 70 transmits a stand-by request Db2 to the laser oscillator 95. As the stand-by request Db2 is received, the laser oscillator 95 switches itself from the initial state to the preparation completion state, and transmits a laser ready OK signal Cb3 and a stand-by OK signal Cb4 to the laser processing control device 70. As the laser ready OK signal Cb3 and the stand-by OK signal Cb4 are received, the laser processing control device 70 transmits an analog control request Db5 for requesting permission for performing control by the laser processing control device 70 to the laser oscillator 9. As the analog control request Db5 is received, the laser oscillator 95 grants permission for performing control under a condition that a predetermined requirement is satisfied, and transmits a laser ON signal Cb6 to the laser processing control device 70.

As described above, the starting processing for the laser oscillator 95 of Type B is completed. Therefore, the user does not need, by using a PLC, by a program language such as a ladder, to selectively execute a starting program corresponding to Type B each time before start of laser processing.

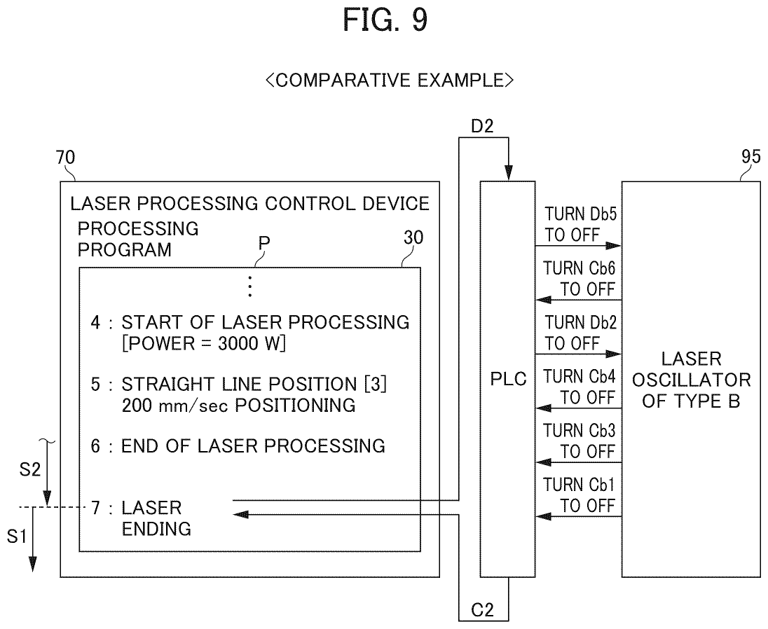

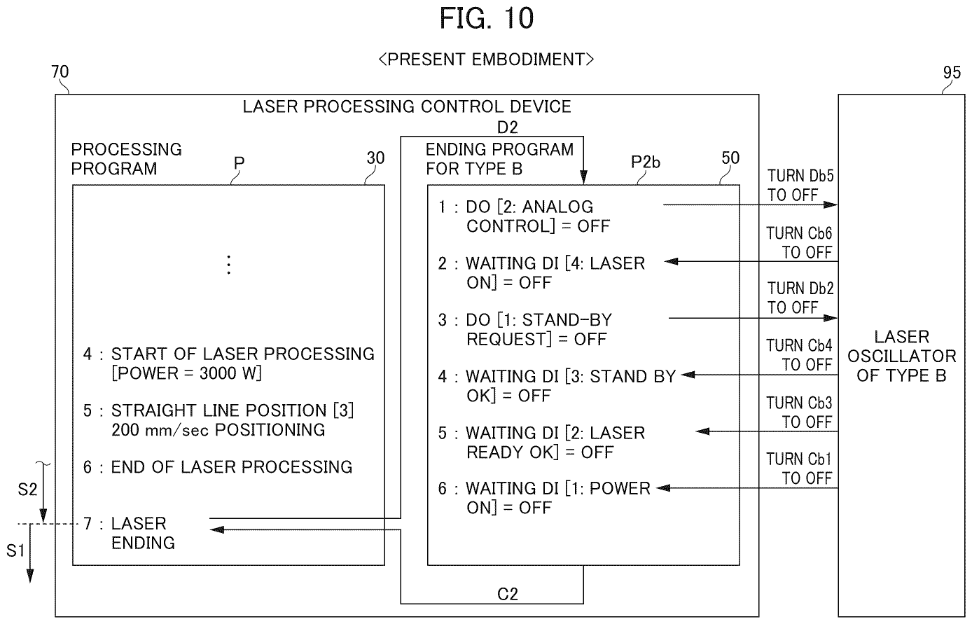

Next, ending processing performed in the present embodiment will now be described herein with reference to FIGS. 9 and 10. If the laser processing control device 70 does not include the automatic switching unit 75, as in a comparative example illustrated in FIG. 9, it is necessary to introduce a PLC in advance. Then, the user needs, by using the PLC, by a program language such as a ladder, to selectively execute an ending program corresponding to Type B each time after end of the laser processing.

On the other hand, in the present embodiment, as illustrated in FIG. 10, after end of the laser processing based on the processing program P, the switching unit 50 automatically reads, from the storage unit 40, and executes an ending program P2b for Type B in accordance with an ending request D2 provided from the control unit 30. Thereby, the ending processing for Type B is automatically executed.

Specifically, in the ending processing for Type B, the laser processing control device 70 first turns the analog control request Db5 to OFF. Based on this setting, the laser oscillator 95 turns the laser ON signal Cb6 to OFF. After that, the laser processing control device 70 turns the stand-by request Db2 to OFF. Based on this setting, the laser oscillator 95 sequentially turns the stand-by OK signal Cb4, the laser ready OK signal Cb3, and the power on signal Cb1 to OFF. In the present embodiment, as described above, the ending processing that is different from that in the first embodiment is implemented.

As described above, the ending processing for the laser oscillator 95 of Type B is completed. Therefore, the user does not need, by using a PLC, by a program language such as a ladder, to selectively execute an ending program corresponding to Type B each time after end of the laser processing.

According to the present embodiment, as described above, it is possible to acquire effects similar to those according to the first embodiment when the laser oscillator 95 is Type B.

### Third Embodiment

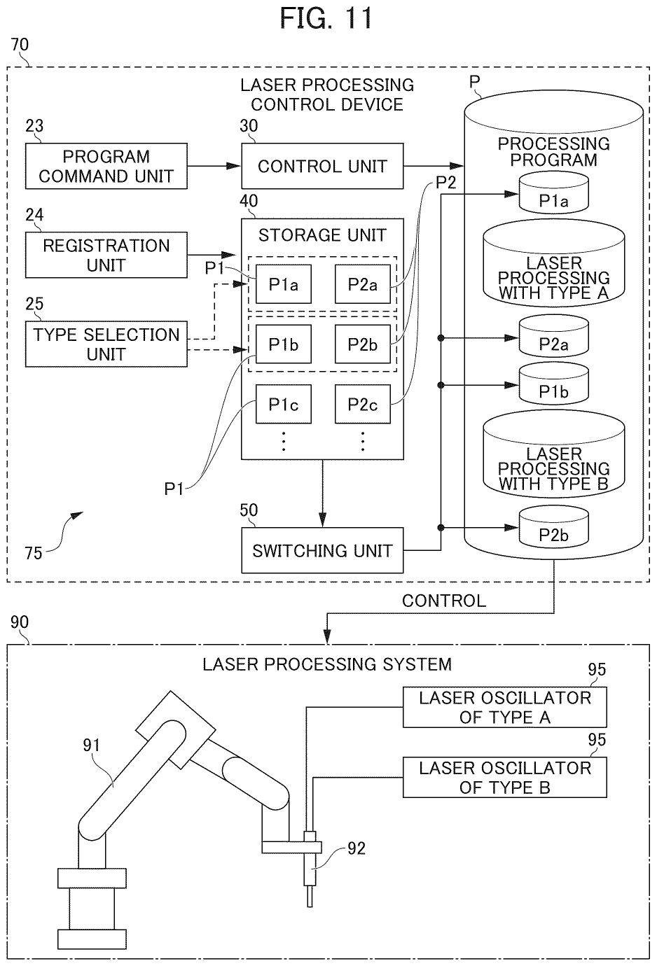

Next, a third embodiment will now be described herein with reference to FIG. 11. In the present embodiment, the laser processing system 90 further includes the laser oscillator 95 of Type B illustrated in the second embodiment, in addition to the laser oscillator 95 of Type A illustrated in the first embodiment. Then, the processing nozzle 92 is configured to allow emission of either a laser provided from the laser oscillator 95 of Type A or a laser provided from the laser oscillator 95 of Type B, which is selectively inputted. Note that, although two laser oscillators 95 and 95 are coupled to one processing nozzle 92 in the diagram, separate processing nozzles 92 and 92 may be provided to the laser oscillators 95 and 95, respectively.

That is, the laser processing control device 70 according to the present embodiment separately uses the laser oscillator 95 of Type A and the laser oscillator 95 of Type B in accordance with a purpose, for example. Therefore, the type selection unit 25 is configured to allow selection of a plurality of types as types of the laser oscillators 95 to be used. Specifically, in the present embodiment, through a manipulation on the type selection unit 25, the user selects Type A as one type of the laser oscillator 95 to be used and selects Type B as another type of the laser oscillator 95 to be used.

In this case, the switching unit 50 reads, from the storage unit 40, and implements the starting program P1a for Type A before using the laser oscillator 95 of Type A based on implementation of the processing program P and reads, from the storage unit 40, and implements the ending program P2a for Type A after using the laser oscillator 95 of Type A. Then, the switching unit 50 reads, from the storage unit 40, and implements the starting program P1b for Type B before using the laser oscillator 95 of Type B based on implementation of the processing program P and reads, from the storage unit 40, and implements the ending program P2b for Type B after using the laser oscillator 95 of Type B.

According to the present embodiment, as described above, the switching unit 50 reads, from the storage unit 40, and executes the switching programs P1a and P2a corresponding to Type A in accordance with using of the laser oscillator 95 of Type A based on execution of the processing program P. Then, the switching unit 50 reads, from the storage unit 40, and executes the switching programs P1b and P2b corresponding to Type B in accordance with using of the laser oscillator 95 of Type B based on execution of the processing program P. Therefore, even when there is a case where a plurality of the laser oscillators 95 are desired to be used in a switched manner, the present embodiment makes it possible to respond to such a case.

### Fourth Embodiment

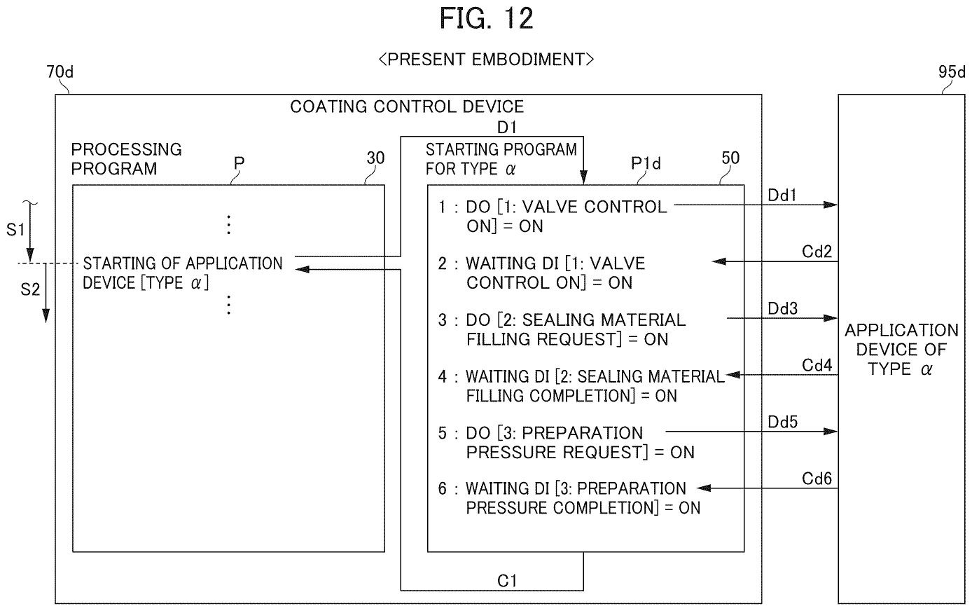

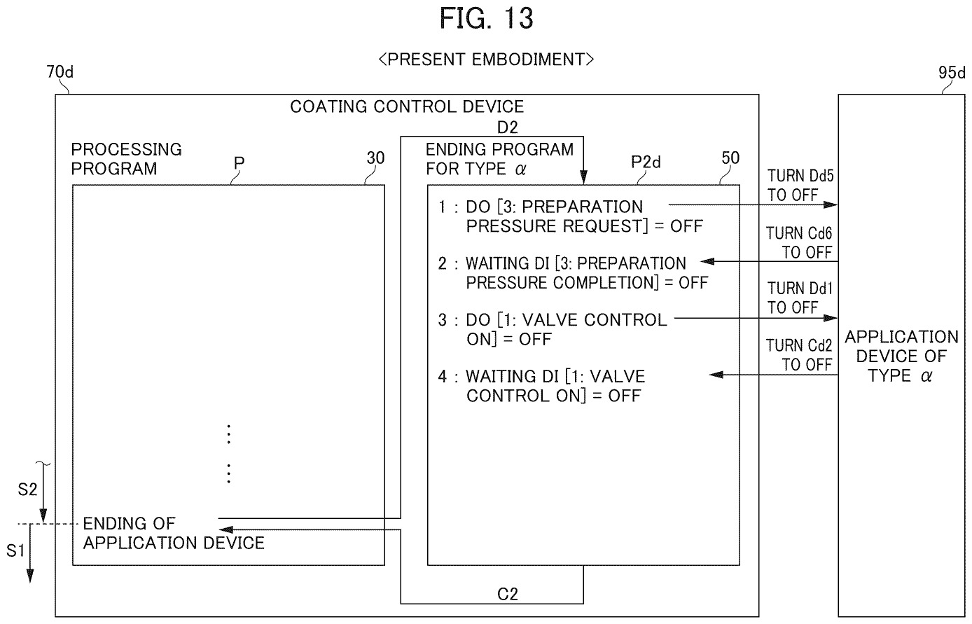

Next, a fourth embodiment will now be described herein with reference to FIGS. 12 and 13. In the present embodiment, a coating system that performs coating on a workpiece is provided instead of the laser processing system, and a coating control device 70d that controls the coating system is provided instead of the laser processing control device 70.

The coating system includes a coating device 95d of Type α. Therefore, in the present embodiment, the user selects Type α through a manipulation on the type selection unit.

Next, starting processing performed in the present embodiment will now be described herein with reference to FIG. 12. Before start of a coating task based on the processing program P, the switching unit 50 automatically reads, from the storage unit, and executes a starting program P1d for Type α in accordance with a starting request D1 provided from the control unit 30. Thereby, the starting processing for Type α is automatically executed.

Specifically, in the starting processing for Type α, the coating control device 70d first transmits, to the coating device 95d, a valve control ON request Dd1 for requesting permission for performing control of a valve of the coating device 95d by the coating control device 70d. As the valve control ON request Dd1 is received, the coating device 95d grants permission for performing valve control under a condition that a predetermined requirement is satisfied, and transmits a valve control ON signal Cd2 to the coating control device 70d. As the valve control ON signal Cd2 is received, the coating control device 70d transmits a sealing material filling request Dd3 to the coating device 95d. As the sealing material filling request Dd3 is received, the coating device 95d fills a sealing material, and transmits a sealing material filling completion signal Cd4 to the coating control device 70d. As the sealing material filling completion signal Cd4 is received, the coating control device 70d transmits a preparation pressure request Dd5 to the coating device 95d. As the preparation pressure request Dd5 is received, the coating device 95d causes internal pressure to increase, and transmits a preparation pressure completion signal Cd6 to the coating control device 70d.

As described above, the starting processing for the coating device 95d for Type α is completed. Therefore, the user does not need, by using a PLC, by a program language such as a ladder, to selectively execute a starting program corresponding to Type α each time before start of coating. After completion of the starting processing, the switching unit 50 transmits a starting completion notification C1 to the control unit 30.

Next, ending processing performed in the present embodiment will now be described herein with reference to FIG. 13. After end of the coating based on the processing program P, the switching unit 50 automatically reads, from the storage unit, and executes an ending program P2d for Type α in accordance with an ending request D2 provided from the control unit 30. Thereby, the ending processing for Type α is automatically executed.

Specifically, in the ending processing for Type α, the coating control device 70d first turns the preparation pressure request Dd5 to OFF. Based on this setting, the coating device 95d lowers the internal pressure, and turns the preparation pressure completion signal Cd6 to OFF. After that, the coating control device 70d turns the valve control ON request Dd1 to OFF. Based on this setting, the coating device 95d cancels the granted permission for performing the valve control, and turns the valve control ON signal Cd2 to OFF.

As described above, the ending processing for the coating device 95d for Type α is completed. Therefore, the user does not need, by using a PLC, by a program language such as a ladder, to selectively execute an ending program corresponding to Type α each time after end of the coating. After completion of the ending processing, the switching unit 50 transmits an ending completion notification C2 to the control unit 30.

According to the present embodiment, as described above, it is possible to acquire effects similar to those according to the first embodiment when the processing system is a coating system and the processing machine is the coating device 95d.

### Other Embodiments

It is possible to modify the embodiments described above as described below, for example. Only one of the starting program P1 and the ending program P2 may be registered through a manipulation on the registration unit 24. Processing corresponding to the other one may be performed using a PLC, as in the cases of the comparative examples.

Instead of selecting a type of the laser oscillator 95 through a manipulation on the type selection unit 25 by the user, the switching unit 50 may automatically recognize a type of the laser oscillator 95 coupled to the processing nozzle 92 from a coupling situation, for example, and the switching programs P1 and P2 corresponding to the recognized type may be executed. With this configuration, it is possible to mitigate a burden on the user for selecting a type of the laser oscillator 95 through a manipulation on the type selection unit 25.

The processing system, which has been the laser processing system in the first to third embodiments, and has been the coating system in the fourth embodiment, may be a system that performs or includes other types of processing. Example of the other types of processing include processing other than laser processing, such as cutting, pressing, pulling, heating, and pressurizing, in order to partially remove, cut, break, deform, or alter a workpiece and processing other than coating, in order to add an appendage to a workpiece.

### EXPLANATION OF REFERENCE NUMERALS

24 Registration unit
25 Type selection unit
30 Control unit
40 Storage unit
50 Switching unit
70 Laser processing control device
70d Coating control device
90 Laser processing system
95 Laser oscillator
95d Coating device
P Processing program
P1 Starting program
P2 Ending program
S1 Initial state
S2 Preparation completion state

1. A processing control device that controls a processing system that uses a processing machine to process a workpiece, the processing control device comprising:
a registration unit configured to allow registration, through a manipulation by a user, of a switching program for switching a state of the processing machine between an initial state in which a predetermined operation for processing the workpiece is not executable and a preparation completion state in which the predetermined operation is executable;
a storage unit that stores the switching program that has been registered; and
a switching unit that reads, from the storage unit, and executes the switching program in accordance with using of the processing machine.

2. The processing control device according to claim 1, wherein
the processing machine is a laser oscillator,
the processing system is a laser processing system that uses a laser outputted from the laser oscillator to perform laser processing on the workpiece,
the initial state is a state in which the laser is not outputtable, and
the preparation completion state is a state in which the laser is outputtable.

3. The processing control device according to claim 1, wherein
the switching program includes a starting program for switching the state of the processing machine from the initial state to the preparation completion state, and
the switching unit reads, from the storage unit, and executes the starting program before using the processing machine.

4. The processing control device according to claim 1, wherein
the switching program includes an ending program for switching the state of the processing machine from the preparation completion state to the initial state, and
the switching unit reads, from the storage unit, and executes the ending program after using the processing machine.

5. The processing control device according to claim 1, wherein
the switching program includes a starting program for switching the state of the processing machine from the initial state to the preparation completion state and an ending program for switching the state of the processing machine from the preparation completion state to the initial state, and
the switching unit reads, from the storage unit, and executes the starting program before using the processing machine and reads, from the storage unit, and executes the ending program after using the processing machine.

6. The processing control device according to claim 1, wherein
the registration unit is configured to allow registration of the switching program per a type of the processing machine,
a type selection unit configured to allow selection, by the user, of a type of the processing machine is further included, and
the switching unit reads, from the storage unit, and executes the switching program corresponding to the type selected through the type selection unit.

7. The processing control device according to claim 1,
further comprising:
a program command unit configured to allow input of a processing program through a manipulation by the user; and
a control unit that controls the processing system based on the processing program that has been inputted,
wherein the switching unit reads, from the storage unit, and executes the switching program in accordance with the using of the processing machine based on execution of the processing program.

8. The processing control device according to claim 7, wherein the registration unit is configured to allow input of the switching program by way of a program language that can be used when inputting the processing program into the program command unit.

9. The processing control device according to claim 7, wherein
the storage unit stores the switching program corresponding to a first type and the switching program corresponding to a second type that is different from the first type,
the processing machine that is the first type and the processing machine that is the second type are used through execution of the processing program, and
the switching unit reads, from the storage unit, and executes the switching program corresponding to the first type in accordance with using of the processing machine that is the first type based on execution of the processing program and reads, from the storage unit, and executes the switching program corresponding to the second type in accordance with using of the processing machine that is the second type based on execution of the processing program.

10. The processing control device according to claim 1, wherein
the switching program includes an ending program for switching the state of the processing machine from the preparation completion state to the initial state, and
the switching unit reads, from the storage unit, and executes the ending program when processing has been interrupted or ended.

11. The processing control device according to claim 1, wherein
the switching program includes a starting program for switching the state of the processing machine from the initial state to the preparation completion state, and
the switching unit reads, from the storage unit, and executes the starting program when processing is to be restarted after the processing has been interrupted.

12. The processing control device according to claim 1, wherein
the switching program includes a starting program for switching the state of the processing machine from the initial state to the preparation completion state, and
the switching unit skips execution of the starting program during a processing disabled period in which a manipulation based on which processing should be disabled has been performed.

13. The processing control device according to claim 12, wherein the processing disabled period includes a period of a teaching mode under which the user teaches the processing system an operation.

14. The processing control device according to claim 1, wherein, in a state before the switching program is registered through a manipulation on the registration unit by the user, the storage unit stores at least a part of the switching program corresponding to a predetermined type of the processing machine.

15. A non-transitory computer-readable storage medium storing a processing control program for causing a computer to function as a processing control device that controls a processing system that uses a processing machine to process a workpiece, and
for causing the computer to further function as units comprising:
a registration unit configured to allow registration, by a user, of a switching program for switching a state of the processing machine between an initial state in which a predetermined operation for processing the workpiece is not executable and a preparation completion state in which the predetermined operation is executable;
a storage unit that stores the switching program that has been registered; and
a switching unit that reads, from the storage unit, and executes the switching program in accordance with using of the processing machine.
